(19) United States
(12) Patent Application Publication
(10) Pub. No.: US 2007/0219846 A1
(43) Pub. Date: Sep. 20, 2007

(54) System and method for providing economic analyses

(76) Inventor: Steven Allen Mogensen, (US)

Correspondence Address: Steven Allen Mogensen, 17689 Lake Oak Circle, Lakeville, MN, 55044, US

(21) Appl. No.: 11/375,491

(22) Filed: Mar. 14, 2006

(51) Int. Cl. G07G 1/00; G06F 17/30

(52) U.S. Cl. 705/10

(57) ABSTRACT

A method and system for performing economic analysis that includes the organization and structure of the economic models, organization and presentation of the content associated with the economic models, the organization and structure of the software models used to construct electronic versions of the economic models and content, the idea of using economic analysis as the basis for interactivity and communication with users, sufficient detail in the economic and software models to accurately represent the real world processes they model, a method for changing assumptions and conducting “what if” analysis, a method for providing automated updates of assumptions, a method allowing users to “lock-in” assumption values, a group of tools allowing users to create, delete, and otherwise manage their proprietary economic cases, administrative management tools, an instruction system, and other features.

### FIELD OF THE INVENTION

The present field of invention relates to computer-aided economic analysis, and more particularly to the integrated research, analysis, representation, and presentation of economic analyses done interactively and by electronic means.

### BACKGROUND OF THE INVENTION

The typical method for conducting economic analysis involves the use, by a single user, of a standalone computer with software, such as Microsoft® Excel®. The user typically creates a simple program for a specific economic analysis that is small in scope. This approach to economic analysis has many limitations.

One limitation is that the user normally has limited programming skills, which limits the sophistication of the application the user can generate. This can limit the complexity, accuracy, and value of the economic analysis.

A second limitation is that of the software itself. For example, Microsoft® Excel® performs well for simple analyses, but lacks the capacity for a full-featured, Internet-enabled economic analysis system.

A third limitation is that a single user often has limited knowledge of economic analysis. This too can limit the complexity, accuracy, and value of the economic analyses so generated.

A fourth limitation is that the user typically has limited knowledge of the content being analyzed. For example, a single user may have knowledge of the processes of a single or a few companies, but does not have knowledge of an industry or other large group perceived as an entity due to common goal, purpose, or other common denominator.

A fifth limitation is the lack of integration and scalability caused by the limitations of the software and user programming ability. It is not possible to integrate functions such as archiving, date sensitivity, automatic data updates, consistent treatment of data, and other functions in a scalable application with the existing approach.

A sixth limitation is the lack of a systematic approach in the existing economic analysis environment. A non-integrated group of programs from a single or collection of users and program authors is not as effective as one program that handles all options and produces analyses of consistent accuracy and precision.

It is also important to note that economic analysis is different from financial analysis. Financial analysis focuses on the analysis of financial (monetary) results, but economic analysis focuses on real equipment, buildings, materials, processes, people, and other real assets used to create products and services. A traditional and accurate economic analysis takes into account real assets, as well as the resultant products, packaging, and other real features of the real world system. A portion of the results of economic analysis can be financial in nature; however, producing a financial result from an economic analysis system is quite different from the common practice of analyzing financial data.

Therefore, there is an on-going need for an integrated, easy-to-use, economic analysis system adapted to provide a consistent, accurate, and precise economic analysis of real world systems. Embodiments of the present invention provide solutions to these problems and provide advantages over conventional economic analysis systems.

### SUMMARY OF THE INVENTION

The present invention overcomes the limitations of the existing methods of doing economic analysis. The present invention includes the organization and structure of the economic models, organization and presentation of the content associated with the economic models, the organization and structure of the software models used to construct electronic versions of the economic models and content, the idea of using economic analysis as the basis for interactivity and communication with users, sufficient detail in the economic and software models to accurately represent the real world processes they model, a method for changing assumptions and conducting “what if” analysis, a method for providing automated updates of assumptions, a method allowing users to “lock-in” assumption values, a group of tools allowing users to create, delete, and otherwise manage their proprietary economic cases, administrative management tools, an instruction system, and other features.

One aspect of the invention is the structure of the economic models. Many individuals create many economic models in many circumstances, but these models lack in qualities such as accuracy, integrated approach, and flexibility for users. Like other analyses in which numbers are the primary means of communication, it is easy to create numeric results, but difficult to create numeric results that accurately represent the real world, products, processes, and results. The economic models of the current invention represent real world products and processes and generate accurate results. This is achieved through a detailed knowledge of the real world being modeled and a correct composition and high level of detail in the economic models, as well as corresponding software to replicate real world systems being modeled.

To represent the real processes being modeled, one example of the organization and detail of the economic models is that the models include the ability to construct a virtual facility that includes the processing and non-processing equipment in the facility. In this manner all parameters of the facility assets including their cost, productivity, space requirements, and other factors are specified in the process of completing the economic analysis. The process of completing the economic analysis includes user or service provider selection of assets from displayed options maintained in a database, selection of area requirements for each asset from suggested or preferred options, assignment to a department, and other options.

Detailed economic models are converted to a software model in order to be interactive with users electronically, and/or through the Internet, in a scalable fashion. The invention utilizes software of the highest level of sophistication in order to properly support the required detail, consistency, accuracy, and features of the economic models and corresponding management tools. For example, an Oracle® database is used for storing data in the system, or any other robust database system.

Features of the economic system include a method for changing assumptions and conducting “what if” analysis, a method for providing automated updates of assumptions, and a method for users to “lock-in” assumption values. Additionally, the economic system includes a group of tools for managing users, for creating economic cases, and for accessing other features.

The present invention creates the ability to provide fully researched cases to the user, or for the user to create proprietary cases from scratch, or for the user to begin with fully researched cases and to modify them to a desired extent.

The first limitation, defined as programming limitations, described in the previous section on the background of the invention is overcome by the invention. This is accomplished by removing the users from the programming function. Programming experts created the programs of the invention for the users, and these programming experts utilized the latest programming techniques and standards of performance to generate the programs. The program thus becomes independent of the programming skills of the users.

The second limitation of the typical economic modeling software is overcome by using software architecture that is sufficient to provide the needed programming sophistication and scalability of electronic communication. Two embodiments of the software architecture are defined in FIGS. 1 and 2 below.

The third limitation of single user economic knowledge is overcome by developing the economic models independent from the user with the required experts. Thus, the sophistication required of the economic models can be generated.

The fourth limitation of user knowledge is overcome by developing economic models independent of the user, by obtaining a detailed and complete understanding of the real world processes being analyzed.

The fifth limitation is overcome with professionally generated programs utilizing a software and hardware architecture that provides features capable of integrating all requirements of the economic models of the invention and capable of scalable electronic and Internet implementation.

The sixth limitation is overcome with the design of the economic models that makes it possible to integrate, for example, all packaging formats into one economic analysis system. This is preferred to the current environment of a group of individual programs for each packaging format.

### BRIEF DESCRIPTION OF THE DRAWINGS

The accompanying drawings, which are incorporated in and constitute a part of this specification, illustrate the invention and together with the description, serve to explain the principle of the invention. The drawings are provided by way of example only, and should in no way be deemed limiting to the scope of the present invention.

FIG. 1 is a simplified block diagram of an economic analysis system according to an embodiment of the present invention.

FIG. 2 is a simplified schematic diagram illustrating an embodiment of the architectural features of the invention including a database, server, and a client computer.

FIG. 3 is a simplified schematic diagram illustrating an alternative embodiment of the architectural features of the invention including multiple databases, multiple servers, an Internet connection, and multiple client computers.

FIG. 4 is a simplified block diagram illustrating an embodiment of the software features of the invention.

FIG. 5 is a simplified flow diagram illustrating a sequence of input screens provided by a software implementation of the economic analysis system according to an embodiment of the present invention.

FIG. 6 is a simplified flow diagram illustrating a sequence of calculations and data transfers provided by a software implementation of the economic analysis system according to an embodiment of the present invention.

FIG. 7 is a screen depiction of a case manager screen within a software implementation of the economic analysis system according to an embodiment of the present invention.

FIG. 8 is a screen depiction of a product format input screen within a software implementation of the economic analysis system according to an embodiment of the present invention.

FIG. 9 is a screen depiction of an efficiency table input screen within a software implementation of the economic analysis system according to an embodiment of the present invention.

FIG. 10 is a screen depiction of a personnel input screen within a software implementation of the economic analysis system according to an embodiment of the present invention.

FIG. 11 is a simplified table of personnel data definitions within a software implementation of the economic analysis system according to an embodiment of the present invention.

FIG. 12 is a simplified table of personnel content in a database of the economic analysis system according to an embodiment of the present invention.

FIG. 13 is a simplified flow diagram illustrating communication and data flow within a software implementation of the economic analysis system according to an embodiment of the present invention.

FIG. 14 is a simplified flow diagram illustrating the logic and actions provided for in the code segment for authentication and privileges according to an embodiment of the present invention.

FIG. 15 is a simplified flow diagram illustrating the logic and actions provided for in the code segment for managing high-level activities according to an embodiment of the present invention.

FIG. 16 is a simplified flow diagram illustrating the logic and actions provided for in the code segment for preferences according to an embodiment of the present invention.

FIG. 17 is a simplified flow diagram illustrating the logic and actions provided for in the code segment for case creation, copy, share, and related functions according to an embodiment of the present invention.

FIG. 18 is a simplified flow diagram illustrating the logic and actions provided for in the code segment for instructions according to an embodiment of the present invention.

FIG. 19 is a simplified flow diagram illustrating the logic and actions provided for in the code segment for information about selectable options according to an embodiment of the present invention.

FIG. 20 is a simplified flow diagram illustrating the logic and actions provided for in the code segment for review, input, selection, and update of assumptions according to an embodiment of the present invention.

FIG. 21 is a simplified flow diagram illustrating the logic and actions provided for in the code segment for generation and display of results according to an embodiment of the present invention.

FIG. 22 is a simplified flow diagram illustrating the logic and actions provided for in the code segment for calculations and data transfers to and from the database according to an embodiment of the present invention.

FIG. 23 is a screen depiction of a database table of material specifications and prices within a software implementation of the economic analysis system according to an embodiment of the present invention.

FIG. 24 is a screen depiction of a database table of labor specifications and prices within a software implementation of the economic analysis system according to an embodiment of the present invention.

### DETAILED DESCRIPTION

In the following detailed description, reference is made to the accompanying drawings that form a part hereof, and in which are shown by way of illustration specific embodiments in which the invention may be practiced. It is to be understood that other embodiments may be utilized and structural changes may be made without departing from the scope of the present invention. While the following discussion is directed to the packaging industry (the industry that manufactures packaging materials), the invention can be used for economic analysis in any number of industries.

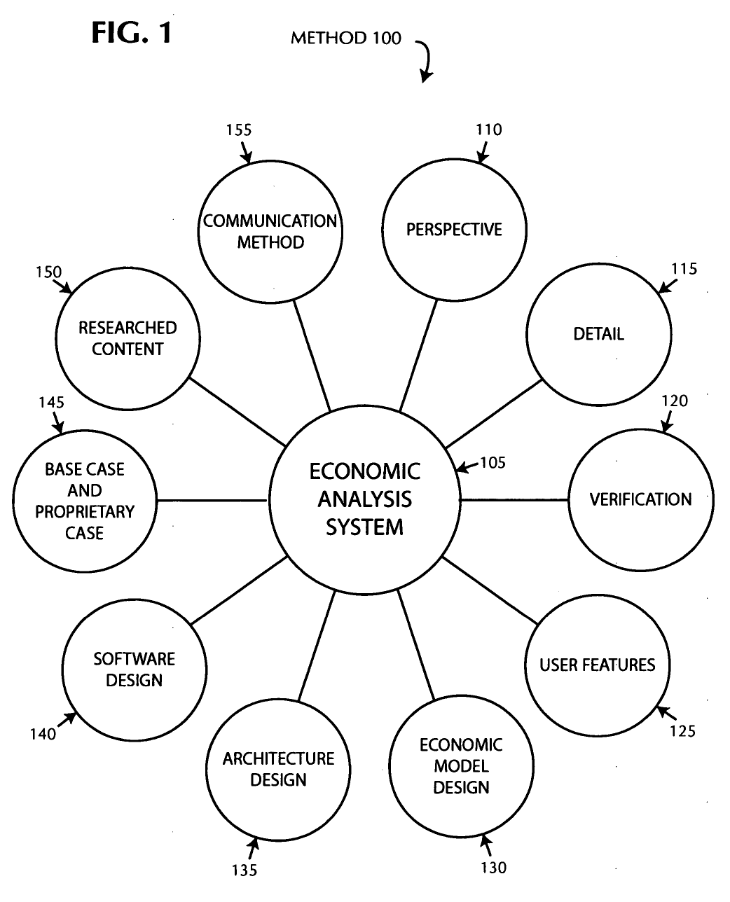

FIG. 1 is a simplified block diagram illustrating the primary concepts of the invention. The economic analysis system 105 is an integration of important concepts. Perspective 110 is the perspective from which the entire system is designed. The perspective can be from any industry, and, in the preferred embodiment, the perspective is from that of the packaging manufacturing industry. This means, for example, that inputs are inputs to the packaging manufacturing industry and results are expressed in terms of the packaging manufacturing industry.

Detail 115 means that sufficient detail 115 must be present in the economic analysis system 105 so the economic analysis system 105 has the capability to accurately represent real world products and processes. Verification 120 means that the economic analysis system 105 should be designed with outputs that can be and are verified to real world products, processes, and results.

User interaction 125 with the economic analysis system 105 must be determined and actuated such that the user has functional and intuitive use of the economic analysis system 105. Typically, this is provided via a graphical user interface, which can be a stand-alone computer application or an Internet-based web page interface to the economic analysis system 105.

Economic model design 130 includes and integrates elements 110-125 with an accurate model of the represented real world products and processes.

The architecture design 135 is the architecture of the computer hardware and software used to develop and serve the software representation of the economic analysis system 105. The architecture design 135 may include one or more servers, routers, firewalls, and other hardware and associated software adapted to allow secure user interaction with the system.

The software design 140 is the software representation of the economic analysis system 105, developed with the hereinabove described hardware and software architecture.

Base case and proprietary case 145 represents the distinction between cases presented with pre-researched content (base case) and cases created and managed by clients (proprietary cases), although it is important that base cases can be copied and edited to create proprietary cases.

Researched content 150 is provided through the economic analysis system 105 and researched content 150 is in addition to the software representation of the economic analysis system 105. Researched content comes with many variations of two primary forms—case data and content selections, such selections that then become case data.

Communication method 155 is the concept of communicating with clients primarily by an economic analysis system 105. The communication method 155 can be a graphical user interface, facsimile or printer communications interface, or via any other communications means.

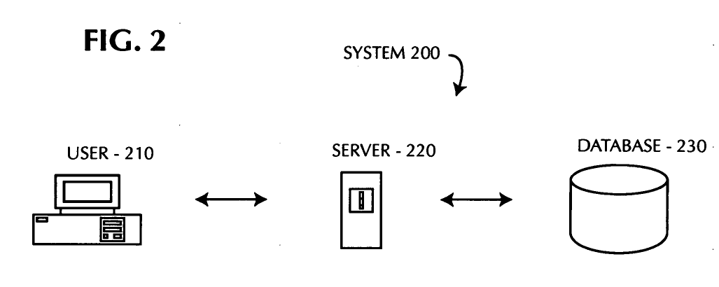

FIG. 2 is a simplified schematic diagram illustrating an embodiment of the architectural system 200 of the invention. This simple embodiment includes a professional and scalable database 230, for example Oracle® 9i Enterprise Database Server, that contains and serves out electronically the hereinabove described case content and selection content. The server 220 can be a combination of a hardware server and a software server, such as Microsoft® Internet Information Server (IIS), that runs the proprietary software program developed to replicate the economic analysis system 105 and also serves out the content requested from the database 230. A user can access the economic analysis system electronically through client computer 210, using Internet-enabled client software, such as Microsoft® Internet Explorer®, which is widely available on client computers.

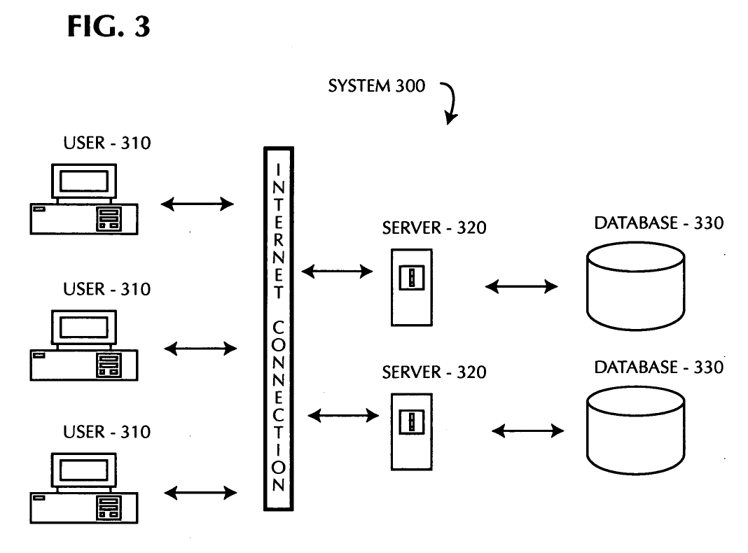

FIG. 3 is a simplified schematic diagram illustrating an alternative embodiment of the architectural features of the invention. This embodiment illustrates the use of multiple databases 330, multiple servers 320, an Internet connection, and multiple client computers 310. This embodiment demonstrates the scalability of the economic analysis system 300, in which any number of databases and servers could be utilized to run the proprietary software and serve out the proprietary content. The Internet connection illustrates that the economic analysis system can be served out through the Internet to a huge number of client computers in parallel.

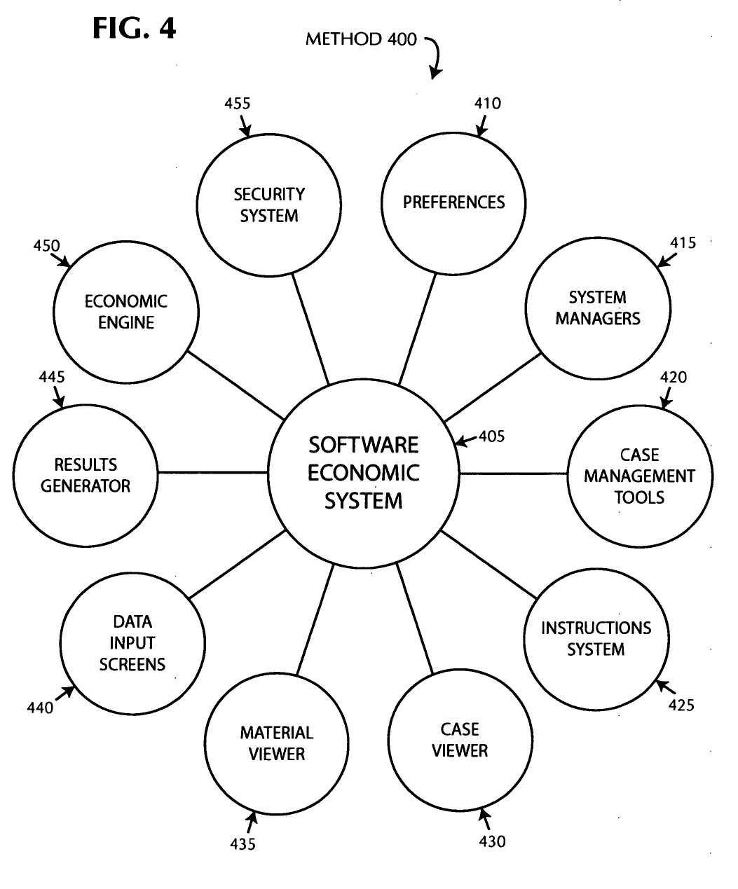

FIG. 4 is a simplified block diagram illustrating an embodiment of the software used to generate the electronic version of the economic models. The software economic system 405 is an integration of a variety of control mechanisms, input devices, data sources, and other components.

Preferences 410 are the screens and corresponding programming that allow the user to select country of manufacture, country of destination, currency, units, and others. Preferences make it possible for the software economic system 405 to include real world products, processes, and assets anywhere in the world.

The system managers 415 include the universal manager, global manager, case manager, and others. The universal manager is a control mechanism and is the first screen and corresponding programming presented after authenticating user identity through the security system 455. The universal manager provides the user a selection of a variety of real world products, processes, and assets.

The global manager is a control mechanism and is the first screen and corresponding programming presented after the universal manager. The global manager provides access to select base cases and proprietary cases, to case viewer 430, to case management tools 420, and to instruction system 425.

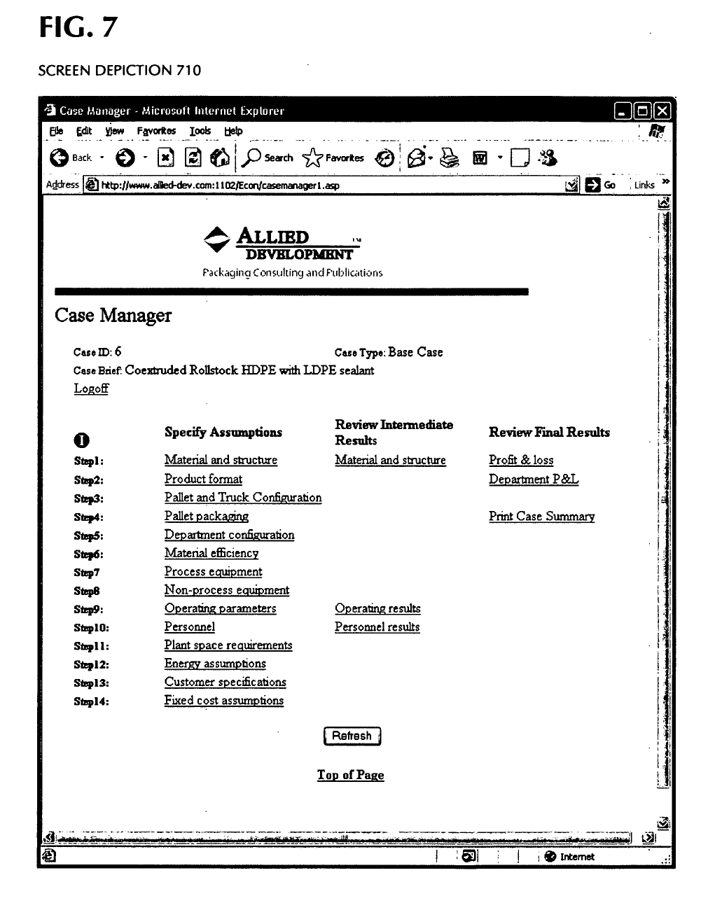

The case manager is a control mechanism that includes the user interface and corresponding programming presented when a base case or proprietary case is selected from the global manager. The primary purposes of the case manager are to provide access to data input screens 440, to intermediate results 445, and to final results 450. An example of a case manager user interface screen depiction 710 is shown in FIG. 7.

The primary purposes of the case management tools 420 screen and corresponding programming are to provide tools that users can utilize to create cases, to define cases, to copy cases, to delete cases, to share cases, and to perform other functions.

The instructions system 425 instructs users about the economic analysis system, provides specific instructions for filling in assumptions, defines the meaning and implications of the results, and makes instructions available when and where needed within the software economic system 405.

The case viewer 430 assists users in learning about and selecting cases to examine, from the base cases and proprietary cases available from the software economic system 405.

The material viewer 435 assists users in learning about and selecting materials for base cases or proprietary cases, from the materials available in the software economic system 405.

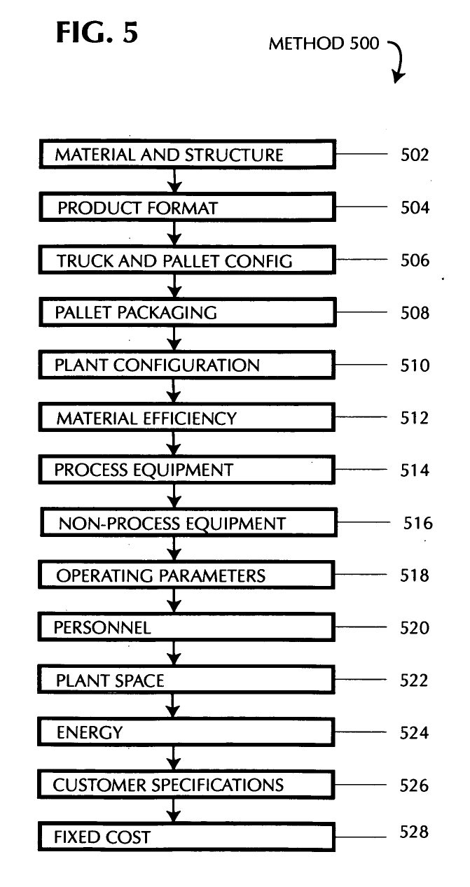

The data input screens 440 assist users to select and specify assumptions. Further explanation is provided in FIG. 5 and other parts of the specification.

The results generator 445 generates intermediate results, where appropriate, and final results. The intermediate results can take many forms, but one intermediate result is the product volume generated by the virtual plant of the software economic system. The final results can take many forms, but one result is a profit and loss statement to plant margin level for the product analyzed.

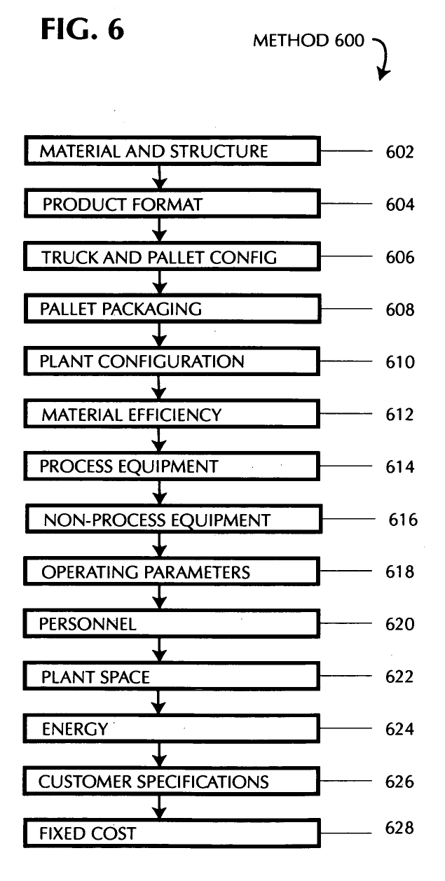

The economic engine 450 performs calculations that convert input data into intermediate and final results. Another purpose is to perform data transfers to and from the database. Further explanation is provided in FIG. 6 and other parts of the specification.

The security system 455 authenticates users, issues permissions, and ensures the software economic system and corresponding content is available only to authenticated users and modified only by permitted users.

FIG. 5 is a simplified flow diagram illustrating an embodiment of the sequence of input screens provided for in the case manager. The design of the economic models and the sequence of the inputs are coordinated in system 500. System 500 begins with the input of information on material and structure 502. This input includes, for example, the structure of the wall of the packaging material.

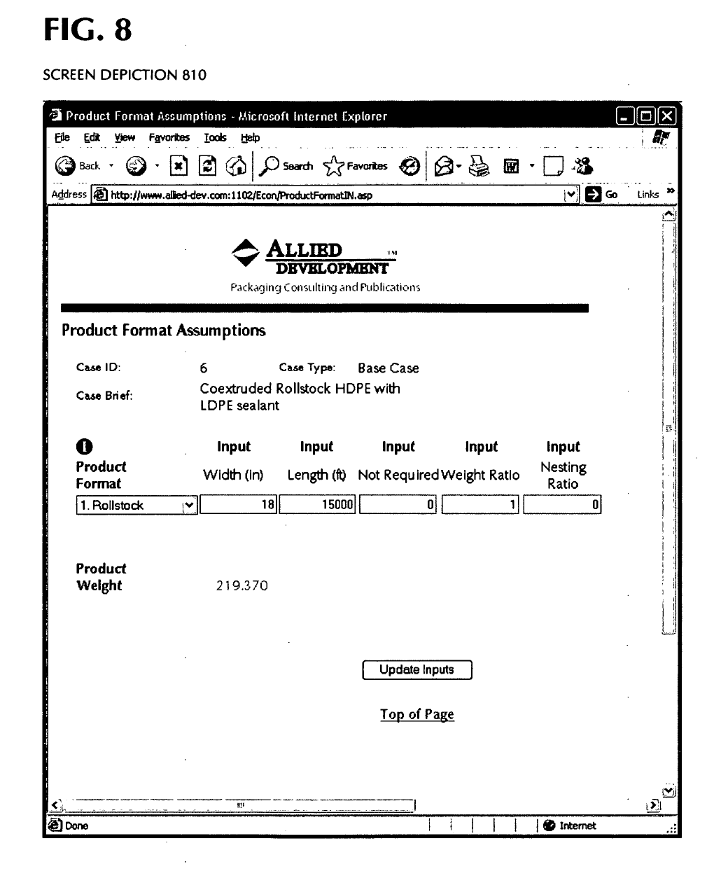

The next input is product format 504, which includes, for example, selecting the product format to be analyzed from a group of product formats stored in the database content. A product format screen depiction 810 is shown in FIG. 8. The next input is truck and pallet configuration 506, which allows the user to specify parameters such as pallet size, truck size, truck weight limit, and others. The next input is pallet packaging 508, which allows the user to specify details of the pallet configuration.

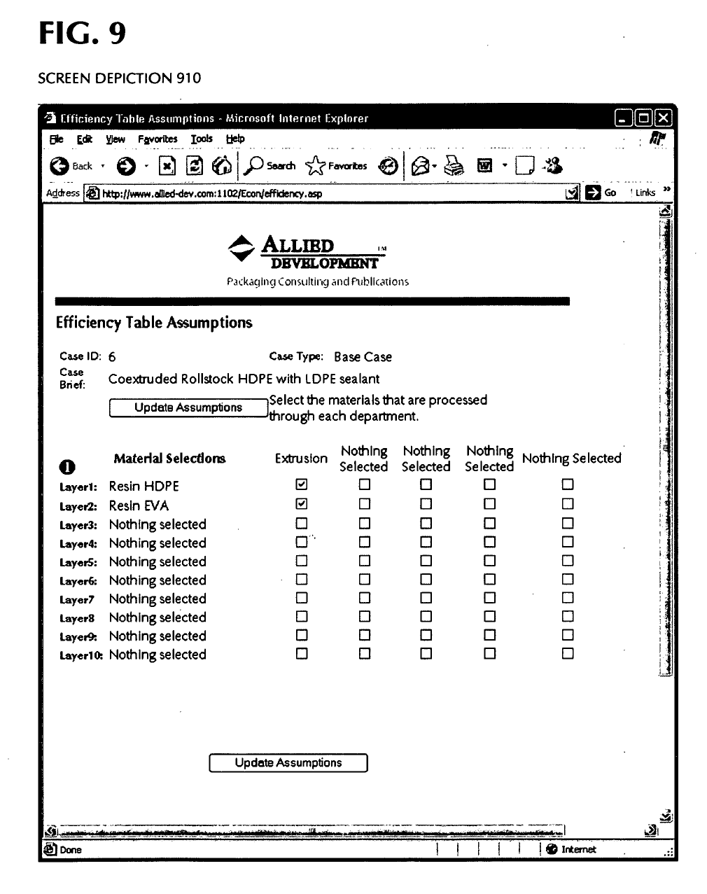

The next input is plant configuration 510, which allows the user to specify the departmental configuration of the plant and the process flow and interrelationships between departments. The next input is material efficiency 512, which allows the user to specify the materials that are processed in each department. A material efficiency screen depiction 910 is shown in FIG. 9. The relationship between plant configuration 510 and material efficiency 512 is a clear example of the sequential dependencies that exist in method 500.

The next input is process equipment 514, which allows the user to select, for example, the type of process equipment used in the virtual plant and the space requirements for this equipment. The next input is non-process equipment 516, which allows the user to specify, for example, the equipment required to support the process equipment and its cost. The next input is operating parameters 518, which allows the user to specify, for example, the available hours to run the equipment, the run speeds, the water factors, and downtime.

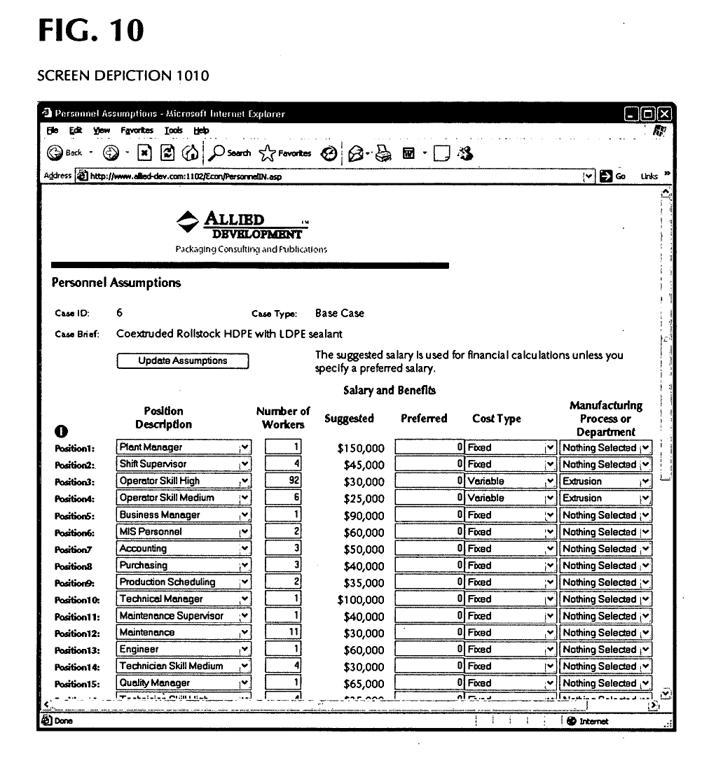

The next input is personnel 520, which allows the user to specify, for example, the workforce that is required to operate the virtual plant. This includes the positions required, the number of workers for each position, and the salary. A personnel screen depiction 1010 is shown in FIG. 10.

The next input is plant space 522, which allows users to specify, for example, the space requirements and the lease cost of the space for the virtual plant. Lease cost is selected from suggested lease cost from content stored in the database or a preferred salary provided by the user. The next input is plant energy 524, which allows users to specify, for example, the cost of energy and energy consumption in the virtual facility. Energy costs are specified by the suggested and preferred concept hereinabove described.

The next input is customer specifications 526, which allows users to specify, for example, the price paid for the product by the customer and the distance from the manufacturing plant to the customer's location.

The next input is fixed cost 528, which allows users to specify, for example, relationships for calculating fixed cost expenses. One example is to specify office supplies as a linear relationship to the number of employees. Another example is to specify maintenance expenses as a percentage of asset value.

FIG. 6 is a simplified flow diagram illustrating an embodiment of the sequence of calculations and data transfer provided for in the economic engine. This embodiment illustrates that the order of the sequence is somewhat restricted in that the results of calculations completed early in the sequence are used in calculations later in the sequence; however, it is possible to use other sequences that include changes to the sequence.

The economic engine begins with material and structure 602. The data transfers conducted by the economic engine related to material and structure include, for example, transferring the material selection and layer thickness of each layer to the database. The calculations related to material and structure include, for example, calculating the weight per area of each layer of the wall of the product. This calculation is completed with a combination of inputs, the material selection and specified thickness for each layer, and stored content from the database and economic engine, including specific gravity, density, and amount of area for each layer. The economic engine also transfers the calculated results to the database. Another calculation performed by the economic engine is to calculate the cost of the material selected for each layer. This calculation also is completed with a combination of inputs and stored content from the database and economic engine.

The economic engine for product format 604 calculates, for example, the product weight of the selected product format and transfers these results to the database. This calculation is completed with a combination of inputs and content stored in the database and economic engine. Some of the stored data used in this calculation was calculated and stored by the economic engine during the previous step in the sequence, material and structure 602.

The economic engine for truck and pallet configuration 606 calculates, for example, suggested quantities of product per pallet and suggested quantities of pallets per truck and transfers these results to the database. Some of the stored data used in this calculation was calculated and stored by the economic engine during the previous steps in the sequence, material and structure 602 and product format 604. Similar statements to that just stated hereinabove will not be repeated in the explanation of each step described hereinbelow, but the concept of building on previous calculation is included by reference.

The economic engine for pallet packaging 608 calculates, for example, the sum of the weights of the packaging materials used to package the product on a pallet or other shipping assistance device. The calculation is completed with a combination of inputs and content stored in the database and economic engine.

The economic engine for plant configuration 610 transfers, for example, the department selections to the database.

The economic engine for material efficiency 612 transfers, for example, the material selections by department to the database.

The economic engine for process equipment 614 calculates, for example, the sum of the asset value for all of the selected process equipment. The economic engine completes the calculation by selecting, through logical comparisons, the proper asset values stored in the database for each user process equipment selection. The economic engine subsequently calculates the total value.

The economic engine for non-process equipment 616 calculates, for example, the total asset value for all of the selected process equipment. The economic engine completes the calculation by selecting, through logical comparisons, the proper asset values stored in the database for each user non-process equipment selection. The economic engine subsequently calculates the total value.

The economic engine for operating parameters 618 calculates, for example, the production volume for each unit of user selected process equipment. The economic engine completes the calculation primarily from the selected assumptions for process equipment stored in the database.

The economic engine for personnel 620 calculates, for example, the total payroll for the virtual plant. The economic engine completes this calculation by first calculating the payroll for each selected workforce position and subsequently calculating the total.

The economic engine for plant space 622 calculates, for example, the total space requirements for the virtual facility. The economic engine completes the calculation by selecting, through logical comparisons, the area requirements for each unit of process equipment, summing the area requirements for each unit of process equipment, and adding the area requirements for office, warehouse, and support areas.

The economic engine for energy 624 calculates, for example, the total energy consumption for the virtual facility. The economic engine completes this calculation with a combination of stored content in the database and economic engine, including energy consumption by area type (office, warehouse, and others) and energy cost, and optionally specified inputs. For example, the energy prices stored in the database are used unless the user specifies preferred energy prices. The economic engine also transfers the calculated results to the database.

The economic engine for customer specifications 626 transfers, for example, the price the customer pays for the product and the distance from the customer to the producing location to the database.

The economic engine for fixed cost 628 calculates, for example, the cost of office supplies for the virtual facility. The economic engine completes this calculation with a combination of stored content in the database and economic engine and input data, including, but not limited to, the number of employees in the virtual facility and the office supply cost per employee. Other calculations include a wide variety of fixed costs including, but not limited to, insurance, taxes, lease cost, maintenance supplies, professional services, and others.

FIG. 7 is a screen depiction of a case manager user interface within the economic analysis system according to an embodiment of the present invention. The case manager user interface provides a selectable list of options with which the operator can interact. Specifically, the user can use a pointer such as a mouse, a track ball, a pen-device, and the like to select items in the list. The case manager then causes the selected item to display.

FIG. 8 is a screen depiction of a product format assumptions page within the economic analysis system according to an embodiment of the present invention. The product format assumption page shown is that of co-extruded rollstock high-density polyethylene (HDPE) with a low-density polyethylene (LDPE) seal layer. The product format and associated product information are accessible through pulldown menus or via data entry fields. Once the product assumptions are filled-in, the operator can update the inputs and perform calculation by clicking the button provided.

FIG. 9 is a screen depiction of efficiency table assumptions within the economic analysis system according to an embodiment of the present invention, associated with the co-extruded rollstock HDPE of FIG. 8. In this instance, the operator can select the materials that are processed through each department, and update assumptions for calculations regarding efficiency.

FIG. 10 is a screen depiction of a personnel assumptions screen within the economic analysis system according to an embodiment of the present invention. Salary can be selected from a suggested salary based on content stored in the database or from a preferred salary provided by the user. The concept used to offer users a choice for salary is used throughout the software economic system 405. The suggested salary is updated periodically and automatically presented to the user. The user can specify the preferred salary, which is preferentially used in all calculations. The preferred salary will not change unless changed by the user, whereas the suggested salary will automatically change when the content is updated in the database.

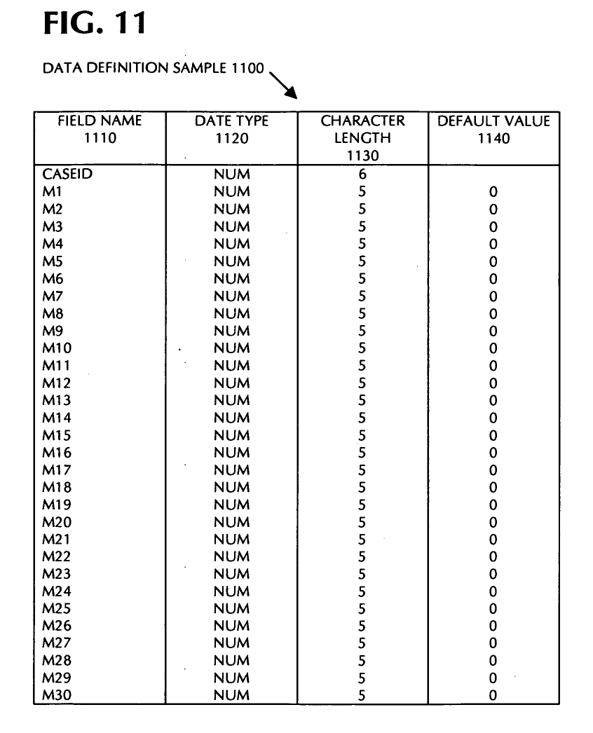

FIG. 11 is a simplified table 1100 of personnel data definitions in the database of the economic analysis system according to an embodiment of the present invention. The field name 1110 is the name assigned in the database to the variables in the database table personnel, which is used to store the personnel position selections. Data type 1120 defined the type of field as number. Character length 1130 defines the number of characters allowed in each field. The default value 1140 sets the default value to be assigned to personnel position selections when a new record is initiated. Data definition sample 1100 illustrates a technique commonly used in the economic analysis system to define data.

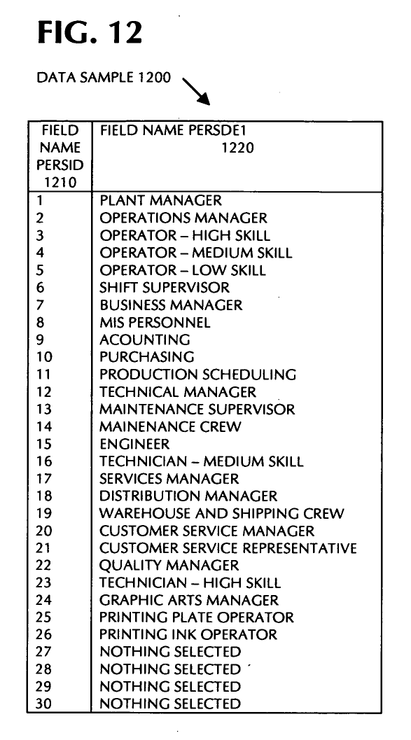

FIG. 12 is a simplified table 1200 of personnel data in a database of the economic analysis system according to an embodiment of the present invention. Field name PERSID 1210 is a field in which is stored a unique number assigned to each position from which a user can select a workforce. Field name PERSDE1 1220 is a field in which position descriptions are stored. Data sample 1200 illustrates a technique commonly used in the economic analysis system to store content.

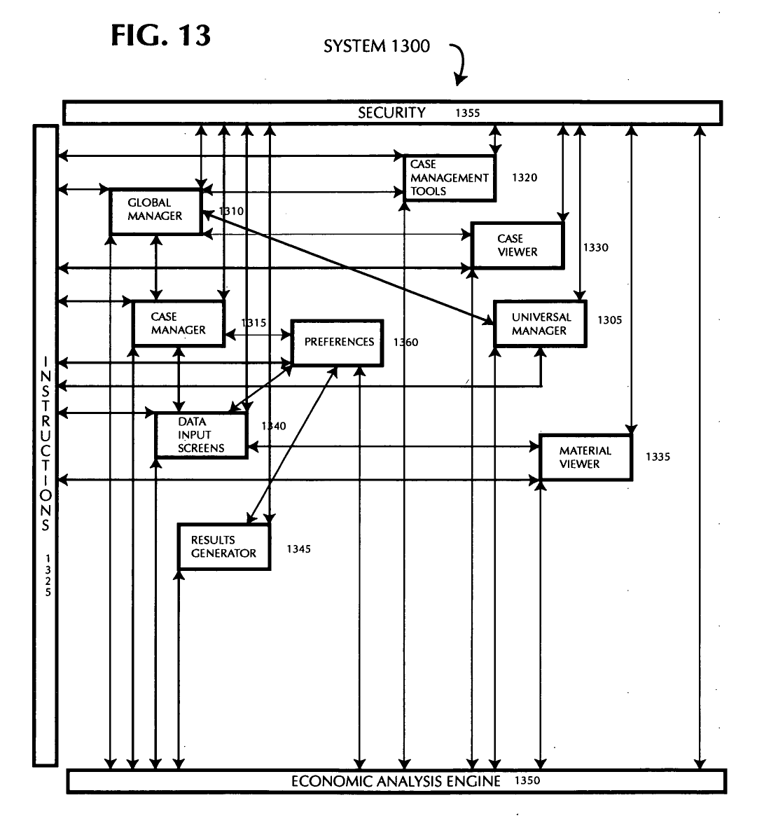

FIG. 13 is a simplified flow diagram illustrating the flow of data and communication between modules by a software implementation of the economic analysis system according to an embodiment of the present invention. For example, the typical flow of information associated with the instructions module is such that a user initiates a request for instructions, which can occur from most screens visible to the user by, for example, clicking on a link with a mouse. The instructions module typically responds with a new screen that provides the instructions. The data input screens 1340 have links to the instructions module, but the reports generator does not, as indicated by the flow arrows in FIG. 13. This same arrow indication technique is used throughout FIG. 13.

In another example, the security module 1355 authenticates users to the system and also continuously receives requests and performs checks for authentication as the system is used. For example, each data input screen 1340 requests authentication of the user from the security module 1355 each time the input screen is displayed. Another example is the economic analysis engine 1350 requests the security system 1355 for permission to update a case each time an update is requested by a user.

Another example of communication and data flow begins with a user request from the global manager 1310 to see the case viewer 1330. The case viewer 1330 then requests case data from the economic analysis engine 1350. The economic analysis engine 1350 subsequently requests a permissions check from the security module 1355, which provides permitted cases. The economic analysis engine 1350 then obtains the required case data and returns it to the case viewer 1330, which displays the data to the user.

There are too many permutations of communication and data flow possible within system 1300 to describe them all; thus, the hereinabove descriptions are used to illustrate the whole of the possible permutations represented in FIG. 13 and possible in the present invention.

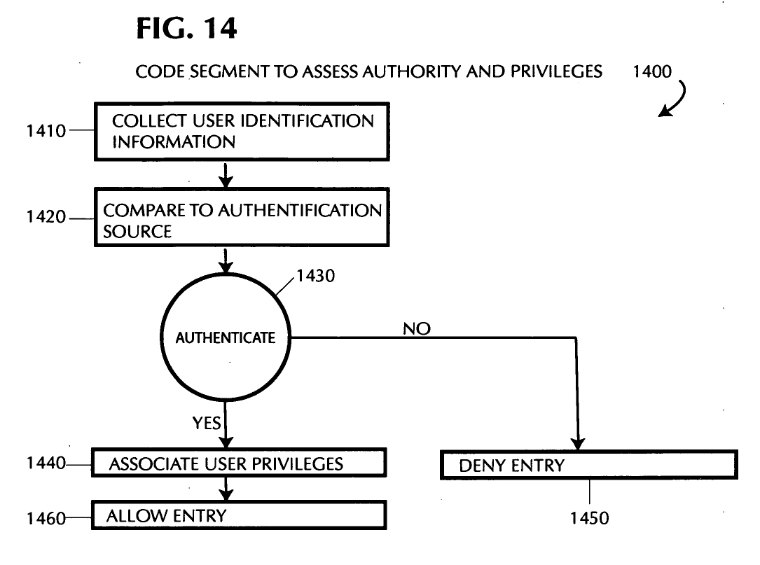

FIG. 14 is a simplified flow diagram illustrating the logic and actions provided for in the code segment for authentication and privileges 1400 according to an embodiment of the present invention. It also further illustrates the flow of data and communication of system 1300 and particularly security model 1355.

Code segment 1400 is the user entry point of system 1300. Code segment 1400 collects user identification information 1410, and it compares the information to authenticity sources 1420. This code segment then authenticates the user or does not authenticate the user 1430. If the user is not authenticated the user is denied entry 1450. If the user is authenticated the user is granted the corresponding privileges 1440, for example to software and content modules and to software and content cases, and allowed entry to the system 1460.

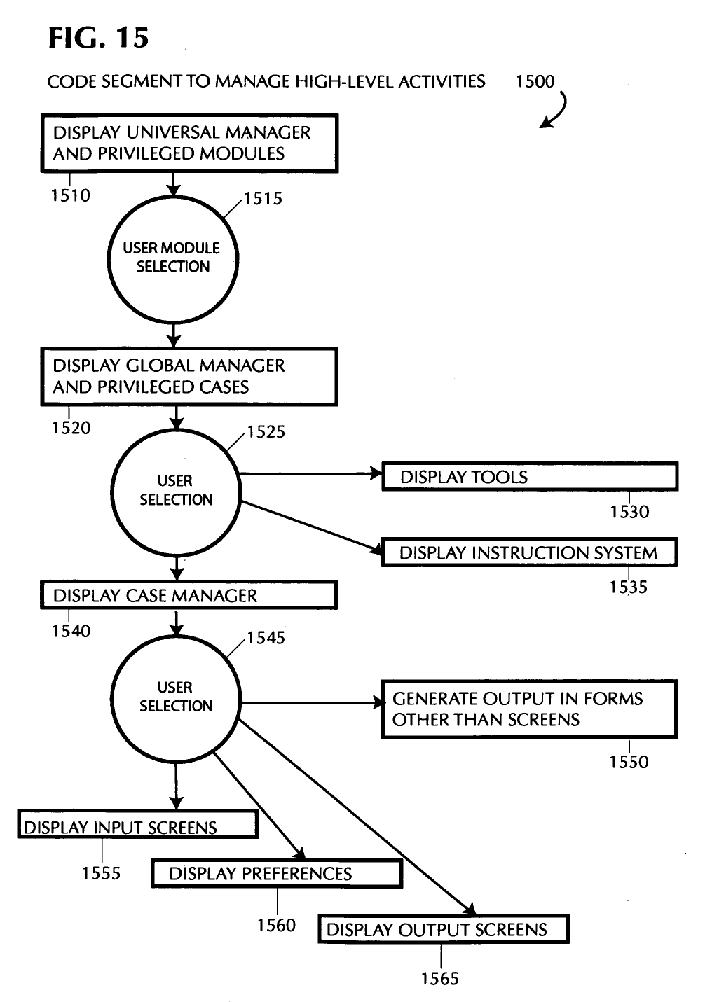

FIG. 15 is a simplified flow diagram illustrating the logic and actions provided for in the code segment for managing high-level activities 1500 according to an embodiment of the present invention. It also further illustrates the flow of data and communication of system 1300 and particularly universal manager 1305, global manager, 1310, and case manager 1315.

Code segment 1500 begins when code segment 1400 allows a user to enter system 1300. Code segment 1500 first displays the universal manager and the corresponding modules for which the user has privileges 1510.

The user has the option in the universal manager to terminate operation of the universal manager and to logoff from system 1300. The user has this option in the global manager, the case manager, and many other positions in system 1300. The option to terminate operations or to logoff is available to the user too frequently to describe them all. These options are described here for the entirety of system 1300 and all code segments 1400,1500, 1600, 1700, 1800, 1900, 2000, 2100, 2200.

Upon display of the universal manager with privileged modules 1510 the user can select a module 1515. Upon user selection of a module the global manager with privileged cases 1520 is displayed. The user can then select a case, select tools, or select instructions.

If the user selects instructions, code segment 1500 displays the instruction manager 1535. If the user selects tools, code segment 1500 displays the tools manager 1530. If the user selects a case, code segment 1500 displays the case manager 1540.

Upon display of the case manager 1540, the user can select input screens, preferences, output screens, and generate output in non-screen forms.

If the user selects input screens, code segment 1500 displays the selected input screen 1555. If the user selects preferences, code segment 1500 displays the preferences screen 1560. If the user selects output screens, code segment 1500 displays the selected output screen 1565. If the user selects non-screen outputs, code segment 1500 generates the selected non-screen output 1550.

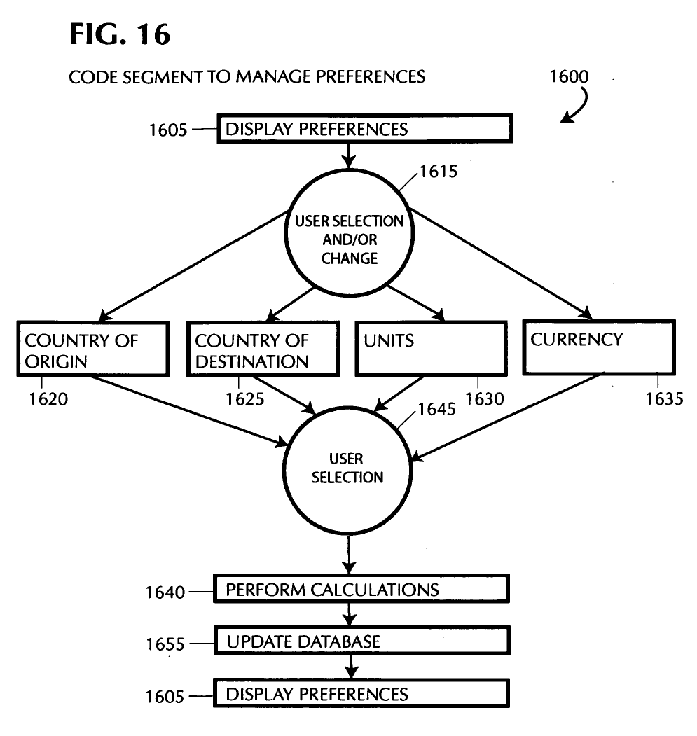

FIG. 16 is a simplified flow diagram illustrating the logic and actions provided for in the code segment for preferences according to an embodiment of the present invention. It also further illustrates the flow of data and communication of system 1300 and particularly preference 1360.

When requested from code segment 1500, code segment 1600 displays the preferences screen 1605. The user can then select preferences such as country of origin 1620, country of destination 1625, units of measure 1630, currency 1635, and other preferences. To enact the selections the user must initiate an update 1645. If the user initiates an update 1645, code segment 1600 performs any needed calculations 1640 and updates the database 1655 then again displays the preferences screen 1605.

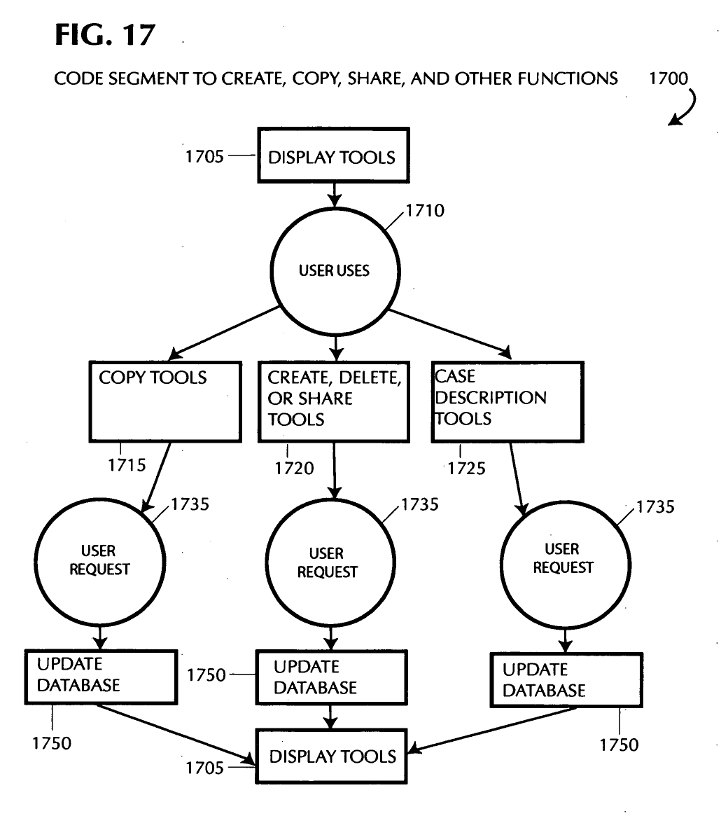

FIG. 17 is a simplified flow diagram illustrating the logic and actions provided for in the code segment for case creation, copy, share, and related functions according to an embodiment of the present invention. It also further illustrates the flow of data and communication of system 1300 and particularly case management tools 1320.

When requested from code segment 1500, code segment 1700 displays the tools manager 1705. The user can then select tools that, for example, copy 1715, create 1720, delete 1720, share 1720, describe 1725, and perform other case management and modification functions. Upon user request 1735 from one of these tools, code segment 1700 updates the database 1750 and again displays the tools manager 1705.

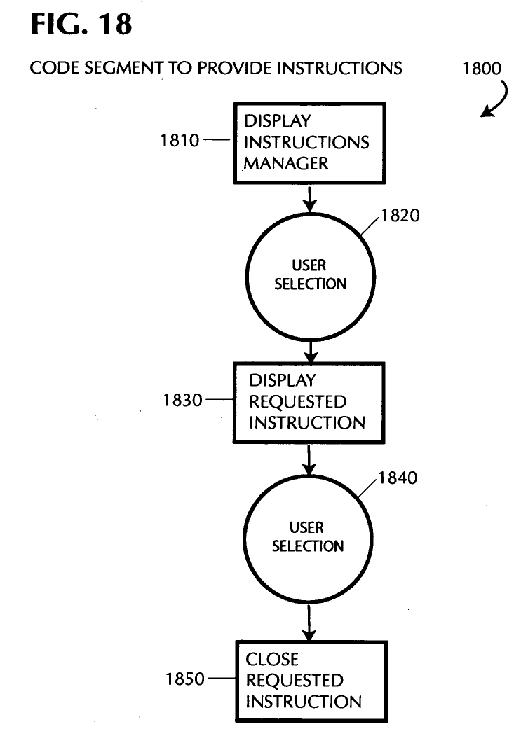

FIG. 18 is a simplified flow diagram illustrating the logic and actions provided for in the code segment for instructions according to an embodiment of the present invention. It also further illustrates the flow of data and communication of system 1300 and particularly instructions 1325.

When requested from, for example, code segment 1500, code segment 1800 displays the instruction manager 1810. The user can then select from many instructions 1820. Upon user selection 1820, code segment 1800 displays the requested instruction 1830. The user can the select to close the instruction 1840, upon which code segment 1800 closes the instruction 1850.

Individual instructions can also be requested by the user from other screens including, but not limited to, input screens 1340, preferences 1360, global manager 1310, case manager 1315, universal manager 1305, case viewer 1330, case management tools 1320, and material viewer 1335.

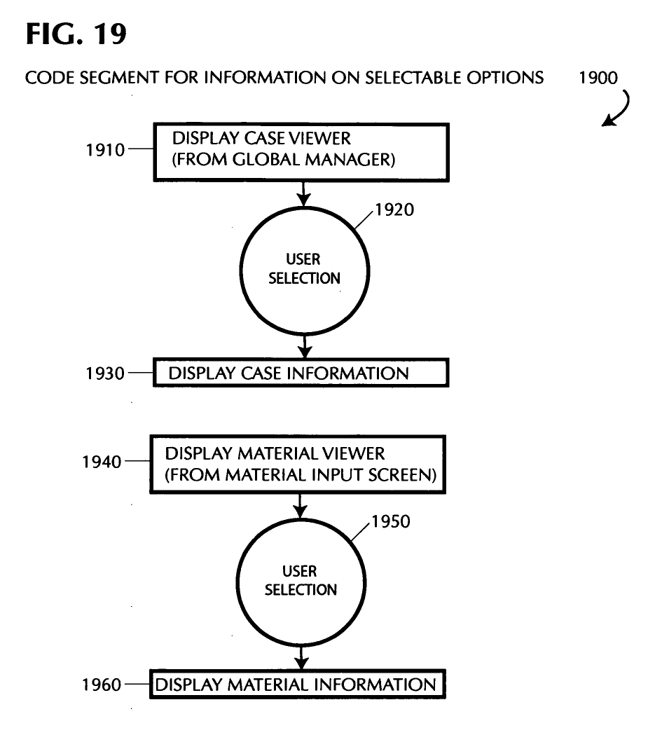

FIG. 19 is a simplified flow diagram illustrating the logic and actions provided for in the code segment for information about selectable options according to an embodiment of the present invention. It also further illustrates the flow of data and communication of system 1300 and particularly case viewer 1330 and material viewer 1335.

When requested from, for example, code segment 1500, code segment 1900 displays the case viewer 1910. The user can then select in multiple ways the case information needed 1920. Upon user selection 1920, code segment 1900 displays the case information 1930.

When requested from, for example, code segment 2000, code segment 1900 displays the material viewer 1940. The user can then select in multiple ways the material information needed 1950. Upon user selection 1950, code segment 1900 displays the case information 1960.

These two viewers are exemplary of the information presentation process, but many additional viewers are possible and include, but are not limited to, labor viewers, energy viewers, equipment viewers, facility viewers, supplies viewers, and services viewers.

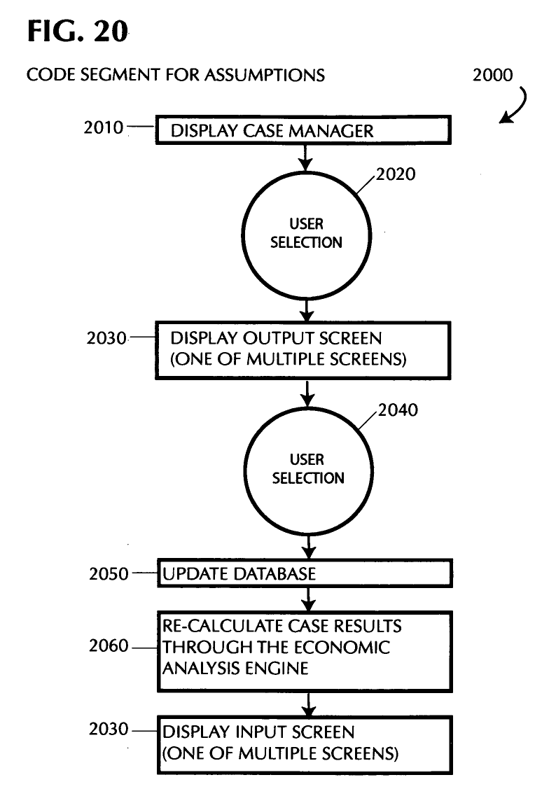

FIG. 20 is a simplified flow diagram illustrating the logic and actions provided for in the code segment for review, input, selection, and update of assumptions according to an embodiment of the present invention. It also further illustrates the flow of data and communication of system 1300 and particularly data input screens 1340.

When requested from code segment 1500, code segment 2000 displays the case manager 2010. The user can then select input screens 2020 from a choice of input screens. Upon user selection of input screen 2020, code segment 2000 displays the requested input screen 2030. The user can then select and input multiple assumptions. Upon user selection, input, and request for update 2040, code segment 2000 updates the database 2050 and re-calculates the case results through the economic analysis engine 2060, and again displays the input screen 2030.

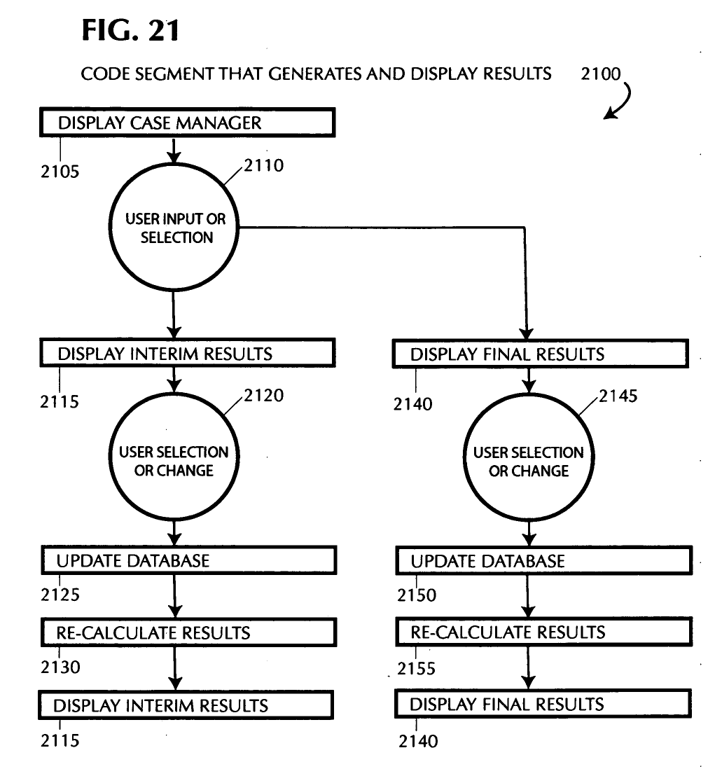

FIG. 21 is a simplified flow diagram illustrating the logic and actions provided for in the code segment for generation and display of results according to an embodiment of the present invention. It also further illustrates the flow of data and communication of system 1300 and particularly results generator 1345.

When requested from code segment 1500, code segment 2100 displays the case manager 2105. The user can then select results screens 2110 and has a choice of interim results or final results.

Upon user selection of interim results, code segment 2100 displays the selected interim results screen 2115. The user can then input, select, and request an update. Upon user request for an update 2120, code segment 2100 updates the database 2125, re-calculates the case results through the economic engine 2130, and again displays interim results 2115.

Upon user selection of final results, code segment 2100 displays the selected final results screen 2140. The user can then input, select, and request an update. Upon user request for an update 2145, code segment 2100 updates the database 2150, re-calculates the case results through the economic engine 2155, and again displays interim results 2140.

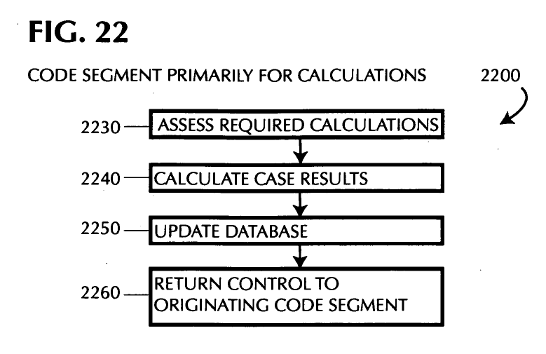

FIG. 22 is a simplified flow diagram illustrating the logic and actions provided for in the code segment for calculations and data transfers to and from the database according to an embodiment of the present invention. It also further illustrates the flow of data and communication of system 1300 and particularly economic analysis engine 1350.

When requested from, for example, code segment 2000, code segment 2200, without further input, automatically accesses required calculations 2230, completes the determined calculations 2240, updates the database 2250, and returns control to the originating code segment 2260.

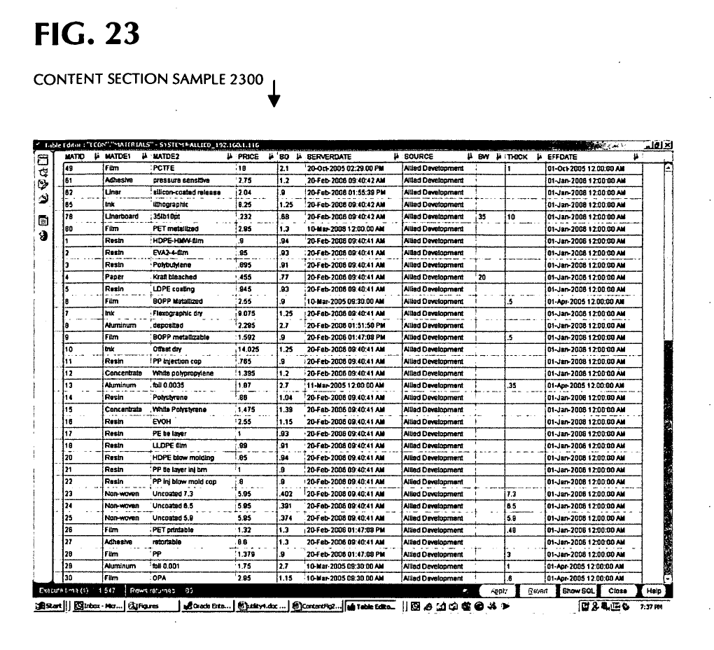

FIG. 23 is a screen depiction of a database table of material specifications and prices within a software implementation of the economic analysis system according to an embodiment of the present invention. It illustrates the columns of a database table and the corresponding data that provide material specifications and prices.

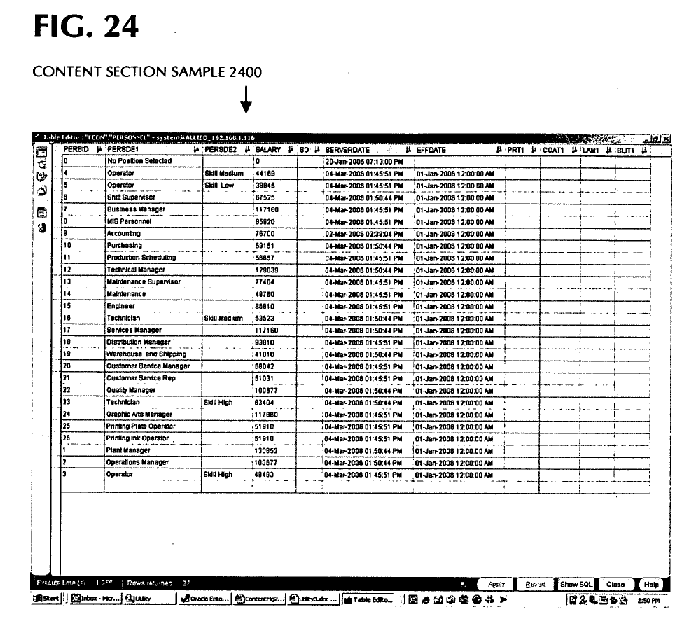

FIG. 24 is a screen depiction of a database table of labor specifications and prices within a software implementation of the economic analysis system according to an embodiment of the present invention. It further illustrates the data organization and storage of sample 1100. FIG. 24 illustrates the columns of a database table and the corresponding data that provide labor specifications and prices.

Other content sections including, but not limited to, energy specifications and prices, equipment specifications and prices, facility specifications and prices, packaging specifications and prices, logistics specifications and prices, supplies specifications and prices, and services specifications and services have a data strategy similar to that depicted in FIG. 23 and FIG. 24.

### Conclusion

Systems and methods consistent with the present invention improve the efficiency and accuracy of economic analysis. Such systems and methods periodically process economic analyses and interact with users.

It will be apparent to those skilled in the art that various modifications and variations can be made in the systems and methods of the present invention without departing from the scope or spirit of the invention. Other embodiments of the invention will be apparent to those skilled in the art from consideration of the specification and practice of the invention disclose herein. It is intended that the specification and examples be considered as exemplary only, with the true scope and spirit of the invention indicated by the following claims:

What is claimed is:

1. A method for performing computer-aided economic analysis comprising the steps of:
providing a computer-based economic analysis software system;
providing content within the software system of a plurality of real world products, processes, and real assets;
providing a user interface within the software system for interaction with an operator;
interacting with the an operator to generate economic analysis.

2. The method of claim 1, wherein said software system further comprises at least one of the following, a result therefrom being used for economic analysis:
a) a code segment for assessing authority to use the system and the corresponding privileges of authorized users;
b) a code segment for users to manage their high-level activities such as selecting modules and cases;
c) a code segment for users to manage their preferences such as country of production, currency, and units;
d) a code segment for users to create, copy, share, and perform other functions on cases;
e) a code segment that provides instructions on economic system operation;
f) a code segment for users to examine information presented to learn about selectable options such as cases and raw materials;
g) a code segment that provides screens to review, input, select, and update assumptions;
h) a code segment that generates and displays results;
i) a code segment that performs calculations and transfers data to and from the database.

3. The method of claim 1 wherein said content system further comprises at least one of the following, the result therefrom being used for economic analysis:
a) a content section that provides raw material specifications and prices;
b) a content section that provides labor specifications and prices;
c) a content section that provides energy specifications and prices;
d) a content section that provides equipment specifications and prices;
e) a content section that provides facility specifications and prices;
f) a content section that provides packaging specifications and prices;
g) a content section that provides logistics specifications and prices;
h) a content section that provides equipment operating specifications;
i) a content section that provides miscellaneous supplies specifications and prices;
j) a content section that provides miscellaneous services specifications and prices.

4. The method of claim 1 wherein said content system further comprises at least one of the following, the result therefrom used for economic analysis
a) assembly of content from each content section into combinations that represent specific real world product, process, and asset combinations
b) assembly of content to create a profit and loss statement result of the specific real world product, process, and asset combination.

5. The method of claim 1 wherein said economic analysis system further comprises at least one of the following, the result therefrom used for economic analysis:
a) A system designed for the packaging manufacturing industry;
b) A system that includes all products manufactured by packaging producers;
c) A system that includes all production processes used by packaging producers;
d) A system that integrates economic analysis of all products and processes used by packaging manufacturers

6. The method of claim 1 wherein said economic analysis system further comprises at least one of the following, the result therefrom used for economic analysis:
a) A system designed for the packaging user industry;
b) A system that includes all packaged products manufactured by product producers or packaging users;
c) A system that includes all production processes used by product producers or packaging buyers;
d) A system that integrates economic analysis of all products and processes used by product producers or packaging buyers

7. The method of claim 1 further comprising:
displaying the generated economic analysis to the operator.

8. The method of claim 1 wherein the user interface is an interactive page displayed within an Internet browser application on a computer.

9. The method of claim 1 wherein the user generates and inputs into the software system all of the content necessary for economic analysis of real world products, processes, and assets for an enterprise.

10. The method of claim 1 wherein the user uses part of the content provided within the software system and generates and inputs into the system the remaining part of the content necessary for economic analysis of real world products, processes, and assets of an enterprise.

11. The method of claim 1 wherein the interaction with the operator includes selections provided by the software system.

12. The method of claim 1 wherein the content provided within the software system is periodically updated.

13. The method of claim 1 wherein individual analyses are compared to one another, breakeven analysis are performed, return on investment analyses are performed, and other types of analyses are performed on content within the software system.

14. A system for generating an economic analysis based on real world products, processes, and assets comprises:
a computer-based economic analysis software system;
content within the software system of a plurality of real world products, processes, and assets;
an interface with operators.

15. The system of claim 14, wherein said software system further comprises at least one of the following, a result therefrom being used for economic analysis:
a) a code segment for assessing authority to use the system and the corresponding privileges of authorized users;
b) code segment for users to manage their high-level activities such as selecting modules and cases;
c) a code segment for users to manage their preferences such as country of production, currency, and units;
d) a code segment for users to create, copy, share, and perform other functions on cases;
e) a code segment that provides instructions on economic system operation;
f) a code segment for users to examine information presented to learn about selectable options such as cases and raw materials;
g) a code segment that provides screens to review, input, select, and update assumptions;
h) a code segment that generates and displays results;
i) a code segment that performs calculations and transfers data to and from the database.

16. The system of claim 14 wherein said content system further comprises at least one of the following, the result therefrom being used for economic analysis:
a) a content section that provides raw material specifications and prices;
b) a content section that provides labor specifications and prices;
c) a content section that provides energy specifications and prices;
d) a content section that provides equipment specifications and prices;
e) a content section that provides facility specifications and prices;
f) a content section that provides packaging specifications and prices;
g) a content section that provides logistics specifications and prices;
h) a content section that provides equipment operating specifications;
i) a content section that provides miscellaneous supplies specifications and prices;
j) a content section that provides miscellaneous services specifications and prices.

17. The system of claim 14 wherein said content system further comprises at least one of the following, the result therefrom used for economic analysis
a) assembly of content from each content section into combinations that represent specific real world product, process, and asset combinations
b) assembly of content to create a profit and loss statement result of the specific real world product, process, and asset combination.

18. The system of claim 14 wherein said economic analysis system further comprises at least one of the following, the result therefrom used for economic analysis:
a) A system designed for the packaging manufacturing industry;
b) A system that includes all products manufactured by packaging producers;
c) A system that includes all production processes used by packaging producers;
d) A system that integrates economic analysis of all products and processes used by packaging manufacturers

19. The system of claim 14 wherein said economic analysis system further comprises at least one of the following, the result therefrom used for economic analysis:
a) A system designed for the packaging user industry;
b) A system that includes all packaged products manufactured by product producers or packaging users;
c) A system that includes all production processes used by product producers or packaging buyers;
d) A system that integrates economic analysis of all products and processes used by product producers or packaging buyers

20. The system of claim 14 wherein the results of the economic analyses are displayed to the operator.

21. The system of claim 14 wherein the display is an interactive page displayed with an Internet browser application on a computer.

22. The system of claim 14 wherein the operator can use only the content supplied within the software system to generate economic analyses.

23. The system of claim 14 wherein the operator can use only content provided by the operator to generate economic analyses.

24. The system of claim 14 wherein the operator can use a mixture of content provided within the software system and provided by the operator to generate economic analysis.

25. The system of claim 14 wherein the content provided within the software system is updated periodically.

26. The system of claim 14 wherein the individual economic analyses are compared to one another, breakeven analyses are completed, return on investment analyses are completed, and other analyses are completed.

27. A method for performing computer-aided economic analysis comprising the steps of:
Providing a computer-based economic analysis software and content system for modeling a virtual product, process, and facility;
Inputting a set of parameters into the computer-based economic analysis system related to modeling a virtual product, process, and facility;
Calculating a set of costs related to fabrication of a virtual product, operation of a virtual process, and operation of a virtual facility, and
Generating a user-selected economic analysis report related to the virtual product, process, and facility.

28. The method for performing computer-aided economic analysis of claim 27, wherein said set of parameters comprises at least one of the following:
a) Material and structure parameters
b) Product format parameters
c) Pallet and truck configuration parameters
d) Pallet packaging parameters
e) Department configuration parameters
f) Material efficiency parameters
g) Process equipment parameters
h) Non-process equipment parameters
i) Operating parameters
j) Personnel parameters
k) Plant space requirements parameters
l) Energy assumptions parameters
m) Customer specifications parameters
n) Fixed cost parameters

29. The method for performing computer-aided economic analysis of claim 27, wherein said set of costs comprises at least one of the following:
a) Material and structure costs
b) Product format costs
c) Pallet and truck configuration costs
d) Pallet packaging costs
e) Department configuration costs
f) Material efficiency costs
g) Process equipment costs
h) Non-process equipment costs
i) Operating costs
j) Personnel costs
k) Plant space requirements costs
l) Energy assumptions costs
m) Customer specifications costs
n) Fixed costs

30. The method for performing computer-aided economic analysis of claim 27, wherein said virtual product, process, and facility is selected from the group consisting of:
a) The packaging manufacturing industry
b) The packaging user industry
c) The chemical manufacturing industry
d) The plastics manufacturing industry
e) The petroleum manufacturing industry
f) The pulp and paper manufacturing industry
g) The plastics processing industry
h) The printing industry
i) The converting industry

31. The method for performing computer-aided economic analysis of claim 27, wherein said economic analysis report is selected from the group consisting of:
a) Material and structure cost report
b) Product format cost report
c) Pallet and truck configuration cost report
d) Pallet packaging cost report
e) Department configuration cost report
f) Material efficiency cost report
g) Process equipment cost report
h) Non-process equipment cost report
i) Operating cost report
j) Personnel cost report
k) Plant space requirements cost report
l) Energy assumptions cost report
m) Customer specifications cost report
n) Profit and loss report
o) Department profit and loss report
p) Line profit and loss report

32. The method for performing computer-aided economic analysis of claim 27, wherein said inputting can be performed by user, by content provider, or a combination thereof.

33. The method for performing computer-aided economic analysis of claim 27, wherein the economic analysis system comprises the following:
a) Preferences
b) System managers
c) Case management tools
d) Instructions system
e) Case viewer
f) Material viewer
g) Data input screens
h) Results generator
i) Economic engine
j) Security system

34. A system for performing computer-aided economic analysis comprising:
A computer-based economic analysis software and content system for modeling a virtual product, process, and facility;
A set of parameters into the computer-based economic analysis system related to modeling a virtual product, process, and facility;
A set of costs related to fabrication of a virtual product, operation of a virtual process, and operation of a virtual facility, and
A user-selected economic analysis report related to the virtual product, process, and facility.

35. The system for performing computer-aided economic analysis of claim 34, wherein said set of parameters comprises at least one of the following:
a) Material and structure parameters
b) Product format parameters
c) Pallet and truck configuration parameters
d) Pallet packaging parameters
e) Department configuration parameters
f) Material efficiency parameters
g) Process equipment parameters
h) Non-process equipment parameters
i) Operating parameters
j) Personnel parameters
k) Plant space requirements parameters
l) Energy assumptions parameters
m) Customer specifications parameters
n) Fixed cost parameters

36. The system for performing computer-aided economic analysis of claim 34, wherein said set of costs comprises at least one of the following:
a) Material and structure costs
b) Product format costs
c) Pallet and truck configuration costs
d) Pallet packaging costs
e) Department configuration costs
f) Material efficiency costs
g) Process equipment costs
h) Non-process equipment costs
i) Operating costs
j) Personnel costs
k) Plant space requirements costs
l) Energy assumptions costs
m) Customer specifications costs
n) Fixed costs

37. The system for performing computer-aided economic analysis of claim 34, wherein said virtual product, process, and facility is selected from the group consisting of:
a) The packaging manufacturing industry
b) The packaging user industry
c) The chemical manufacturing industry
d) The plastics manufacturing industry
e) The petroleum manufacturing industry
f) The pulp and paper manufacturing industry
g) The plastics processing industry
h) The printing industry
i) The converting industry

38. The system for performing computer-aided economic analysis of claim 34, wherein said economic analysis report is selected from the group consisting of:
a) Material and structure cost report
b) Product format cost report
c) Pallet and truck configuration cost report
d) Pallet packaging cost report
e) Department configuration cost report
f) Material efficiency cost report
g) Process equipment cost report
h) Non-process equipment cost report
i) Operating cost report
j) Personnel cost report
k) Plant space requirements cost report
l) Energy assumptions cost report
m) Customer specifications cost report
n) Profit and loss report
o) Department profit and loss report
p) Line profit and loss report

39. The system for performing computer-aided economic analysis of claim 34, wherein said inputting can be performed by user, by content provider, or a combination thereof.

40. The system for performing computer-aided economic analysis of claim 34, wherein the economic analysis system comprises the following:
a) Preferences
b) System managers
c) Case management tools
d) Instructions system
e) Case viewer
f) Material viewer
g) Data input screens
h) Results generator
i) Economic engine
j) Security system
